(19) United States
(12) Patent Application Publication
(10) Pub. No.: US 2011/0298598 A1
(43) Pub. Date: Dec. 8, 2011

(54) System and Method for Low Latency Sensor Network

(76) Inventor: Sokwoo Rhee, Lexington, MA (US)

(21) Appl. No.: 12/792,399

(22) Filed: Jun. 2, 2010

(51) Int. Cl. G08B 9/00

(52) U.S. Cl. 340/286.02

(57) ABSTRACT

A system and method for low latency sensor network schedules transmissions in the network is described herein. In some embodiments of the technology, information associated with at least two network devices is received. Each network device can be associated with at least one event in a sequence of events. A first schedule entry in a schedule can be determined for each of the at least two network devices based on the received information. At least a part of the schedule can be transmitted to each of the at least two network devices.

### BACKGROUND

Wireless sensor networks have different characteristics and capabilities for the network configuration, and different sensor networks can be selected depending on applications. Many applications in factory automation environments require a high density of wireless sensors in a relatively confined area, and very low latency for the transmission of data of these sensors. These applications also require high reliability so that any missed data communication should be recovered in a short time.

Conventional wireless sensor networks always have trade-offs in the requirements. For example, low latency transmissions and high density network devices cannot be easily achieved at the same time in many conventional wireless sensor network designs. There is a limitation of the number of sensor devices that can run simultaneously in the same area since low latency can usually be achieved by giving each sensor device more frequent access to the valuable communication channels. Thus, a need exists in the field for a low latency transmission sensor network.

### SUMMARY

One approach to low latency sensor networks is a method for scheduling transmissions in a network. The method includes receiving information associated with at least two network devices. Each network device is associated with at least one event in a sequence of events. The method further includes determining a first schedule entry in a schedule for each of the at least two network devices based on the received information and transmitting at least a part of the schedule to each of the at least two network devices.

Another approach to low latency sensor networks is a method for scheduling transmissions in a network. The method includes transmitting information associated with an event in a sequence of events. The method further includes receiving at least part of a schedule. The schedule is generated based on the event in the sequence of events. The method further includes transmitting data based on the at least part of the schedule.

Another approach to low latency sensor networks is a computer program product. The computer program product is tangibly embodied in an information carrier. The computer program product includes instructions being operable to cause a data processing apparatus to receive information associated with at least two network devices. Each network device is associated with at least one event in a sequence of events. The computer program product further includes instructions being operable to cause a data processing apparatus to determine a first schedule entry in a schedule for each of the at least two network devices based on the received information and transmit at least a part of the schedule to each of the at least two network devices.

Another approach to low latency sensor networks is a system for scheduling transmissions in a network. The system includes a scheduler module and a communication module. The scheduler module configured to determine a first schedule entry in a schedule for each of at least two network devices based on information. The communication module configured to receive the information associated with the at least two network devices. Each network device is associated with at least one event in a sequence of events. The communication module further configured to transmit at least part of the schedule to each of the at least two network devices.

Another approach to low latency sensor networks is a system for scheduling transmissions in a network. The system includes a network interface module and a control module. The network interface module is configured to transmit information associated with an event in a sequence of events and receive at least part of a schedule, the schedule generated based on the event in the sequence of events. The control module is configured to generate data for transmission based on the at least part of the schedule.

Another approach to low latency sensor networks is a system for scheduling transmissions. The system includes a means for receiving information associated with at least two network devices, each network device associated with at least one event in a sequence of events; a means for determining a first schedule entry in a schedule for each of the at least two network devices based on the received information; and a means for transmitting at least a part of the schedule to each of the at least two network devices.

In other examples, any of the approaches above can include one or more of the following features.

In some examples, the determining the first schedule entry further includes identifying at least one available schedule entry in the schedule for each of the at least two network devices. The at least one available schedule entry occurs at or after a time slot of the least one event associated with the respective network device.

In other examples, the determining the first schedule entry further includes identifying at least one available schedule entry in the schedule for each of the at least two network devices based on schedule conflict information.

In some examples, the method further includes identifying a schedule conflict associated with a network device based on schedule conflict information; determining a second schedule entry in the schedule for the network device based on the identified schedule conflict; and transmitting the second schedule entry to the network device.

In other examples, the method further includes generating the schedule conflict information based on the received information.

In some examples, the method further includes identifying a channel conflict associated with the schedule based on channel conflict information; determining an available channel for the schedule; and transmitting the available channel to each of the at least two network devices associated with the schedule.

In other examples, the method further includes generating the channel conflict information based on the received information.

In some examples, the method further includes determining at least one retry entry in the schedule for a network device based on the received information.

In other examples, the method further includes transmitting a request for the received information to the at least two network devices.

In some examples, the at least part of the schedule includes the first schedule entry, a plurality of schedule entries before the first schedule entry in the schedule, and/or a plurality of schedule entries after the first schedule entry in the schedule.

In other examples, the method further includes generating the transmitted information based on the event.

In some examples, the schedule module is further configured to identify at least one available schedule entry in the schedule for each network device. The at least one available schedule entry occurs at or after a time slot of the least one event associated with the respective network device.

In other examples, the schedule module is further configured to identify at least one available schedule entry in the schedule for each network device based on schedule conflict information.

In some examples, the system further includes a schedule conflict module. The schedule conflict module is configured to identify a schedule conflict associated with a network device of the at least two network devices based on schedule conflict information, and determine a second schedule entry in the schedule for the network device based on the identified schedule conflict.

In other examples, the communication module is further configured to transmit the second schedule entry to the network device.

In some examples, the system further includes a multi-network schedule conflict module. The multi-network schedule conflict module is configured to identify a channel conflict associated with the schedule based on channel conflict information and determine an available channel for the schedule.

In other examples, the communication module is further configured to transmit the available channel to each of the at least two network devices associated with the schedule.

In some examples, the schedule module is further configured to determine at least one retry entry in the schedule for at least one network device of the at least two network devices based on the received information.

In other examples, the control module is further configured to generate the information based on the event.

An advantage is that the low latency sensor network utilizes the characteristic of many typical factory automation applications—“periodicity”—in determining a schedule for the sensor network thereby increasing the reliability and throughput of the sensor network. Another advantage is that the low latency sensor network enables sensors to access the sensor network in a periodic time frame thereby increasing the density of the sensor network, i.e., more sensors can communicate on the sensor network.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 illustrates an exemplary low latency sensor network;

FIG. 2 illustrates an exemplary management server utilized in another exemplary low latency sensor network;

FIG. 3 illustrates an exemplary gateway utilized in another exemplary low latency sensor network;

FIG. 4 illustrates an exemplary wireless sensor utilized in another exemplary low latency sensor network;

FIGS. 5A-5E illustrate wireless sensors utilized in another exemplary low latency sensor network;

FIG. 6A depicts an exemplary event schedule;

FIG. 6B depicts exemplary observed transmissions;

FIG. 6C depicts an exemplary communication schedule based on the observed transmissions;

FIG. 6D depicts another exemplary communication schedule with retry slots based on the observed transmissions;

FIG. 7A depicts another exemplary event schedule;

FIG. 7B depicts an exemplary time-frequency map of observed transmissions;

FIG. 7C depicts another exemplary communication schedule based on the time-frequency map;

FIG. 8 depicts an exemplary flowchart of a generation of a low latency sensor network communication schedule;

FIG. 9 depicts another exemplary flowchart of a generation of a low latency sensor network communication schedule;

FIG. 10 depicts another exemplary flowchart of a generation of a low latency sensor network communication schedule; and

FIG. 11 depicts another exemplary flowchart of a generation of a low latency sensor network communication schedule.

### DETAILED DESCRIPTION

Generally, low latency sensor network technology, in some examples, is utilized in manufacturing processing environments. For example, a factory automation machine setup can include a plurality of multiple limit switches that control the on-off activities or movements of an automation process. In most instances, the movements of the factory machines are generally periodic. As a result, the on-off schedules of the limit switches are also mostly periodic, although the period of each switch may vary based on the process being performed. The technology can measure actual timings of these periodic motions, and can assign appropriate schedule entries (e.g., time slots, frequency channels, etc.) for each device (e.g., switch, robotic arm, etc.). After the initial scanning, the technology can generate a schedule (e.g., time-frequency map, channel map, etc.) of the network. The technology can adjust the schedule so that each network device will have a dedicated schedule entry (e.g., time slot and frequency channel). When the schedule is completed, the technology can communicate all or part of the schedule to each network device (e.g., just the schedule for the device, the schedule for the device and the available slots, the entire schedule for the network, etc.). An advantage of the technology is that the schedule can be customized for the particular setup of the network thereby reducing conflicts and latency, thereby increasing the efficiency of the network.

As a further general overview, the technology can assign additional dedicated schedule entries for one or more of the network devices. The additional schedule entries can be scheduled immediately after the first schedule entry (e.g., on different frequency channels) so that the retry occurs in a very short latency in case of the trouble with the first communication attempt. The minimum slot size can define the retry latency. The retry latency can be the time between the first communication attempt and the next available communication attempt. The retry latency can be less than 2 ms in duration. In the case a retry schedule entry fails, the network device can use the next available schedule entry in the schedule (i.e., avoiding the schedule entries already assigned to other devices), and can keep retrying to transmit the communication in the next available schedule entries. If a network device periodically fails in the first attempts, the gateway can re-adjust the schedule entries of the network device and update the schedule accordingly.

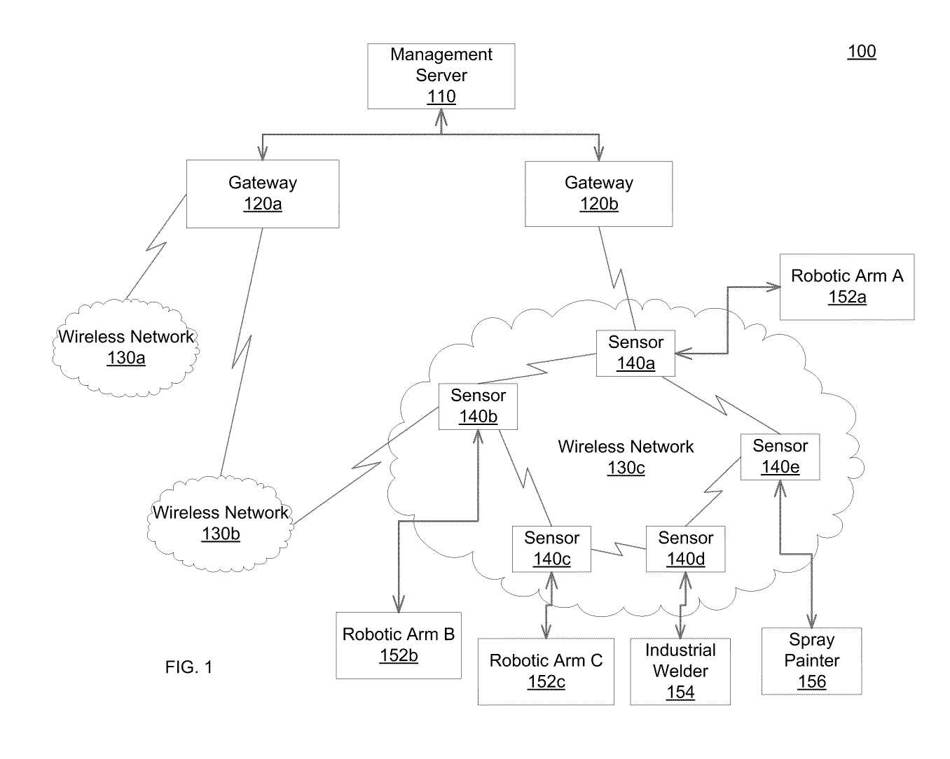

FIG. 1 illustrates an exemplary low latency sensor network (LLSN) 100. The LLSN 100 includes a management server 110, gateways 120a and 120b (generally referred to as gateway 120), and a plurality of wireless networks 130a, 130b, and 130c (generally referred to as wireless network 130). The wireless network 130c includes wireless sensors 140a, 140b, 140c, 140d, and 140e (generally referred to as wireless sensor 140).

One or more devices can be associated with each wireless sensor 140. These devices can include, for example, a conveyer belt, an assembly line, a robotic arm, a robotic welder, a robotic painter, a motion control device, an assembly device, a programmable controller, an automated fabrication device, a pump, and/or any other type of automated device. Robotic arm A 152a is associated with the wireless sensor 140a, robotic arm B 152b is associated with the wireless sensor 140b, robotic arm C 152c is associated with the wireless sensors 140c, an industrial welder 154 is associated with the wireless sensor 140d, and a spray painter 156 is associated with the wireless sensor 140e.

As an example of the operation of the LLSN 100, at power initialization, the gateways 120 start hopping channels in a given interval (e.g., 2 ms for each channel, 5 ms for each channel, etc.). At the power initialization of each device 152a, 152b, 152c, 154, and 156, each device via the associated wireless sensor 140 synchronizes with the appropriate gateway 120 and follows a timing and channel hopping schedule of an initial gateway schedule. Each device transmits information associated with an event (e.g., the event data) as soon as any event occurs. If the device does not receive an acknowledge packet from the gateway 120 (e.g., due to a conflict, due to interference, etc.), the device retries to contact the gateway following a regular random back-off schedule. The retry packets can include the event timing information for the failed attempts so that the gateway 120 can learn the actual event timing when it received the retry packets.

Each device can send “heartbeat” packets to the gateway 120 at regular time intervals even if there is no event. The “heartbeat” packet can be, for example, a transmission control protocol/internet protocol (TCP/IP) packet, a user datagram packet (UDP), an acknowledgement packet, an empty packet, and/or any other type of network transmission. The “heartbeat” packets can ensure that the communication link is always alive between the device and the gateway.

The gateway 120 can scan all incoming information (e.g., event data) and/or heartbeat packet data during a first cycle of a machine operation (e.g., assembly of one vehicle, assembly of ten vehicles, etc.). The cycle time can be pre-configured or automatically identified if the cycle time cannot be predetermined before the start of the machine operation.

After the gateway 120 scans a full cycle (or multiple cycles), the gateway 120 generates a schedule (e.g., TF map) of the event/heartbeat timings of all the devices in the system 100. The gateway 120 adjusts the schedule to avoid any schedule conflict of devices. The gateway 120 can identify the schedule entries (e.g., timings, channels, etc.) that no device is assigned.

After the schedule is complete, the gateway 120 communicates with each device and communicates the partial or entire schedule to each device. After this, each device has the schedule required for operation in the system 100, including the device's own dedicated retry slots, if any.

After this setup process, the system 100 can operate in a contention-free manner. If there is any trouble because of unexpected interference during continuous operation, the device can use its one or more retry channels to communicate with the gateway. If all the given retry attempts fails, each device can identify the next available schedule entry (e.g., free time slot and frequency channel) without contacting the gateway 120, or can request the gateway 120 to assign more retry slots. When the gateway 120 receives a retry packet, the gateway 120 can analyze the schedule, and if a certain device repeatedly fails for the first attempts, the gateway 120 can assign the device to a different schedule entry in real time to clean up the conflicts, and communicates the new schedule to the device. In this way, the system 100 can run in the most optimized condition with the least communication conflicts.

Although FIG. 1 illustrates wireless sensors 140 and devices associated with wireless network 130c, each wireless network 130 can include a plurality of wireless sensors and associated devices.

Although the gateway 120 is described in reference to FIG. 1 as managing the schedule (e.g., receiving information, determining schedule entries), the management server 110 can manage the schedule. In other examples, the management server 110 manages schedules for a plurality of wireless networks 130. Further, the gateway 120 can be a single gateway or multiple gateways.

In some examples, the management server 110 coordinates schedules between a plurality of gateways 120. The management server 110 can identify schedule conflicts between network devices in different wireless networks 130. The management server 110 can communicate these schedule conflicts to the appropriate gateways 120 of the wireless networks 130 and/or can modify the schedules of the networks 130 to resolve the schedule conflicts.

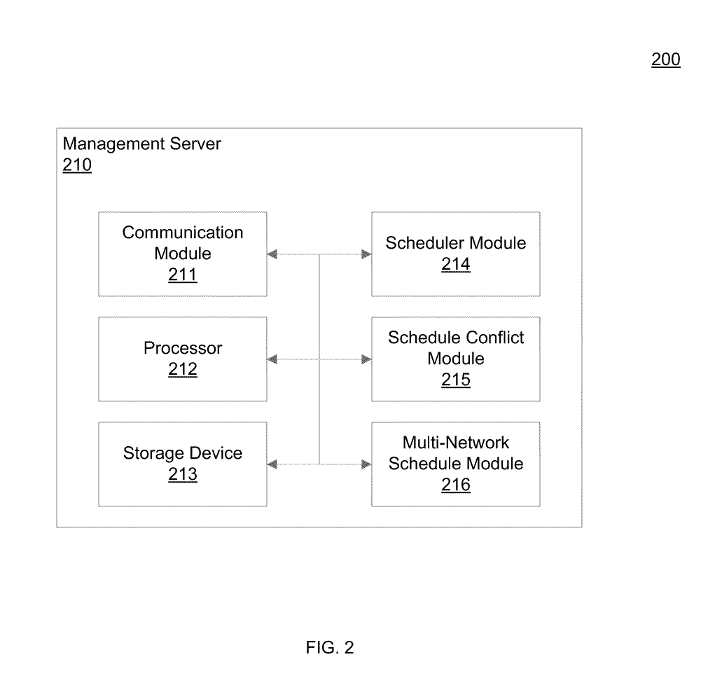

FIG. 2 illustrates an exemplary management server 210 utilized in another exemplary low latency sensor network 200. The server 210 includes a communication module 211, a processor 212, a storage device 213, a scheduler module 214, a schedule conflict module 215, and a multi-network schedule module 216. The modules and devices described herein can, for example, utilize the processor 212 to execute computer executable instructions and/or include a processor to execute computer executable instructions (e.g., a graphic processing unit, a field programmable gate array processing unit, etc.). It should be understood that the server 210 can include, for example, other modules, devices, and/or processors known in the art.

The communication module 211 receives the information associated with the network devices. Each network device is associated with at least one event (e.g., robotic arm movement, welder action, etc.) in a sequence of events (e.g., assembly of a car, manufacture of a part, etc.). The communication module 211 transmits part or all of the schedule to each of the network devices.

The processor 212 executes computer executable instructions associated with the technology and/or any other computing functionality. The storage device 213 stores information and/or data associated with the technology and/or any other computing functionality. The storage device 213 can be, for example, any type of storage medium, any type of storage server, and/or group of storage devices (e.g., network attached storage device, a redundant array of independent disks device, etc.).

The scheduler module 214 determines a first schedule entry in a schedule for each network device in a plurality of network devices based on the received information associated with the network device (e.g., event data, transmission data, etc.). The schedule module 214 can determine the first schedule entry by determining the first available schedule entry at or after a time slot associated with the received information. For example, if the received information is associated with the time slot of 6-8 ms and all available time slots of 6-8 ms are occupied (i.e., in all of the channels), the schedule module 214 can assign the network device to the time slot of 8-10 ms on a specified channel.

The schedule conflict module 215 identifies a schedule conflict associated with a network device based on schedule conflict information and/or determines a second schedule entry in the schedule for the network device based on the identified schedule conflict. The communication module 211 can transmit the second schedule entry to the network device. The schedule conflict module 215 can identify a schedule conflict by monitoring the retry schedule entries and/or the available schedule entries. If the schedule conflict module 215 determines that a network device is transmitting in the retry schedule entries and/or the available schedule entries above a set threshold (e.g., 60% of the transmissions, 40% of the transmissions, etc.), the schedule conflict module 215 can determine the second schedule entry based on this conflict. In this example, the schedule conflict module 215 can modify the schedule entry assigned to the network device and assign the network device to the appropriate retry schedule entry or available schedule entry.

The multi-network schedule module 216 identifies a channel conflict associated with the schedule based on channel conflict information and/or determines an available channel for the schedule. The communication module can transmit the available channel to each network device associated with the schedule. The multi-network schedule module 216 can identify a channel conflict by monitoring the retry schedule entries and/or the available schedule entries associated with each channel. If the multi-network schedule module 216 determines that a network device is transmitting in the retry schedule entries and/or the available schedule entries above a set threshold (e.g., 60%, 40%, etc.), the multi-network schedule module 216 can determine the available channel based on this conflict. In this example, the multi-network schedule module 216 can modify the schedule entry assigned to the network device and assign the network device to the appropriate available channel.

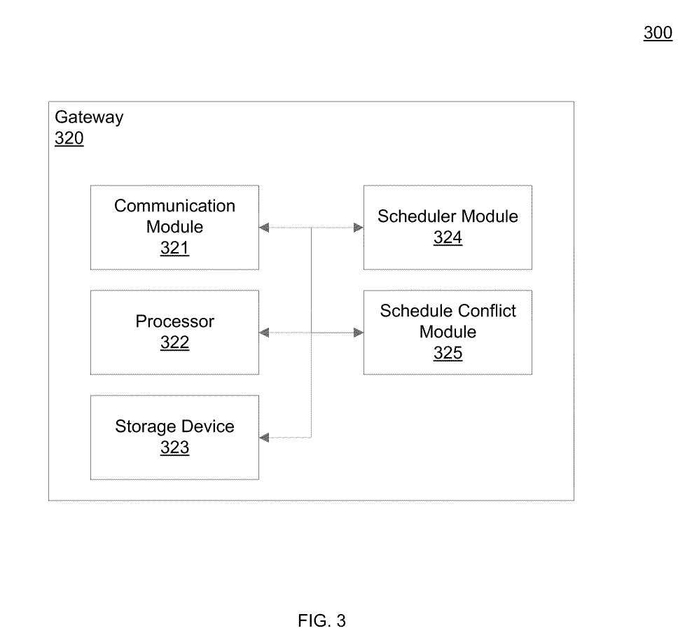

FIG. 3 illustrates an exemplary gateway 320 utilized in another exemplary low latency sensor network 300. The gateway 320 includes a communication module 321, a processor 322, a storage device 323, a scheduler module 324, and a schedule conflict module 325. The modules and devices described herein can, for example, utilize the processor 322 to execute computer executable instructions and/or include a processor to execute computer executable instructions (e.g., a graphic processing unit, a field programmable gate array processing unit, etc.). It should be understood that the gateway 320 can include, for example, other modules, devices, and/or processors known in the art.

The communication module 321 receives the information associated with the network devices. Each network device is associated with at least one event (e.g., robotic arm movement, welder action, etc.) in a sequence of events (e.g., assembly of a car, manufacture of a part, etc.). The communication module 321 transmits part or all of the schedule to each of the network devices.

The processor 322 executes computer executable instructions associated with the technology and/or any other computing functionality. The storage device 323 stores information and/or data associated with the technology and/or any other computing functionality. The storage device 323 can be, for example, any type of storage medium, any type of storage server, and/or group of storage devices (e.g., network attached storage device, a redundant array of independent disks device, etc.).

The schedule module 324 determines a first schedule entry in a schedule for each network device in a plurality of network devices based on information (e.g., event data, transmission data, etc.). The schedule module 324 can determine schedule entries in a plurality of schedules for network devices in a plurality of networks. The schedule module 324 can determine the first schedule entry utilizing any of the techniques described herein.

The schedule conflict module 325 identifies a schedule conflict associated with a network device based on schedule conflict information and/or determines a second schedule entry in the schedule for the network device based on the identified schedule conflict. The communication module 321 can transmit the second schedule entry to the network device. The schedule conflict module 325 can identify the schedule conflict utilizing any of the techniques described herein and/or can determine the second schedule entry utilizing any of the techniques described herein.

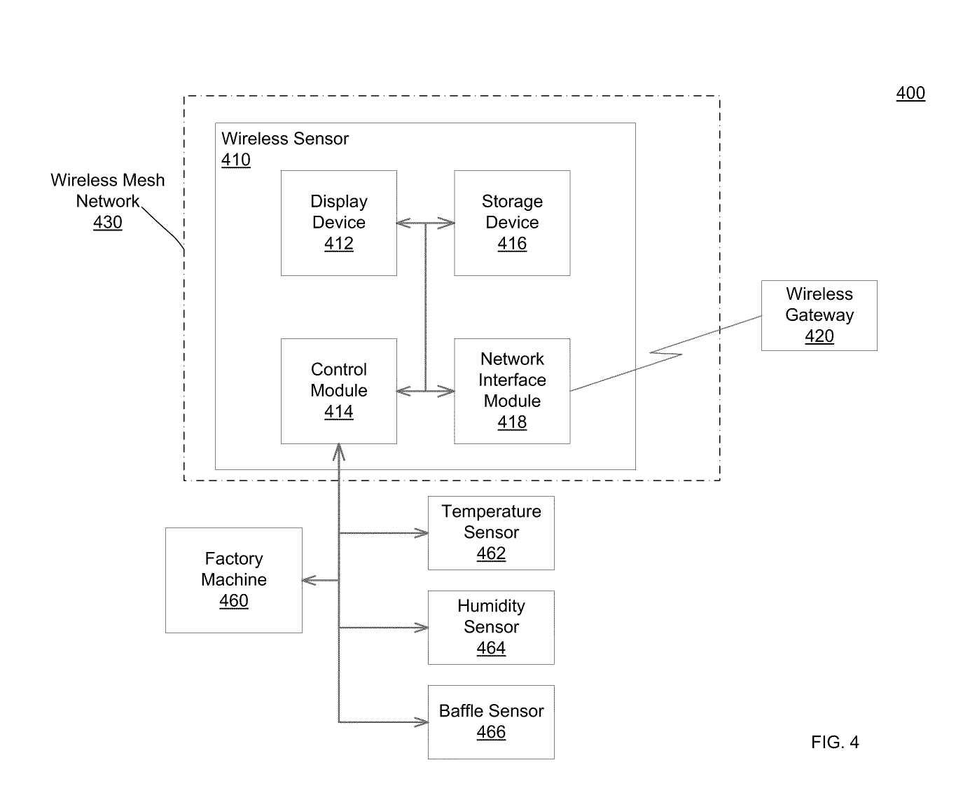

FIG. 4 illustrates an exemplary wireless sensor 410 utilized in another exemplary low latency sensor network 400. The low latency sensor network 400 includes a wireless mesh network 430, a wireless gateway 420, a factory machine 460, a temperature sensor 462, a humidity sensor 464, and a baffle sensor 466. The wireless sensor 410 is associated with the wireless mesh network 430. The wireless sensor 410 includes a display device 412, a control module 414, a storage device 416, and a network interface module 418. The modules and devices described herein can, for example, utilize a processor (not shown) in the wireless sensor 410 to execute computer executable instructions and/or include a processor to execute computer executable instructions (e.g., a graphic processing unit, a field programmable gate array processing unit, etc.). It should be understood that the wireless sensor 410 can include, for example, other modules, devices, and/or processors known in the art.

The display device 412 displays information associated with the event, part or all of the schedule, and/or any other information associated with the wireless sensor 410 (e.g., information about the associated factory machine 460, humidity information received from the humidity sensor 464, etc.).

The control module 414 generates data for transmission based on the at least part of the schedule. The control module 414 generates the information based on the event. The control module 414 can generate data for transmission based on the at least part of the schedule by analyzing the schedule to determine the schedule entry associated with the wireless sensor 410 and scheduling the transmission of data associated with the wireless sensor 410 based on the determined schedule entry. For example, if the schedule entry for the wireless sensor 410 is for transmission at time slot=4-6 ms and channel=1, the control module 414 generates a data packet for transmission at time slot=4-6 ms and channel=1. In this example, the generated data packet is communicated to the network interface module 418 for transmission as described herein.

The storage device 416 stores information and/or data associated with the technology and/or any other computing functionality. The storage device 416 can be, for example, any type of storage medium, any type of storage server, and/or group of storage devices (e.g., network attached storage device, a redundant array of independent disks device, etc.).

The network interface module 418 transmits information associated with an event in a sequence of events to the wireless gateway 420 via the wireless mesh network 430. The event can be associated with the operation of the factory machine 460. The information associated with the event can be associated with the temperature sensor 462, the humidity sensor 464, and/or the baffle sensor 466.

The network interface module 418 receives at least part of a schedule. The schedule can be generated by the wireless gateway 420 based on the event in the sequence of events.

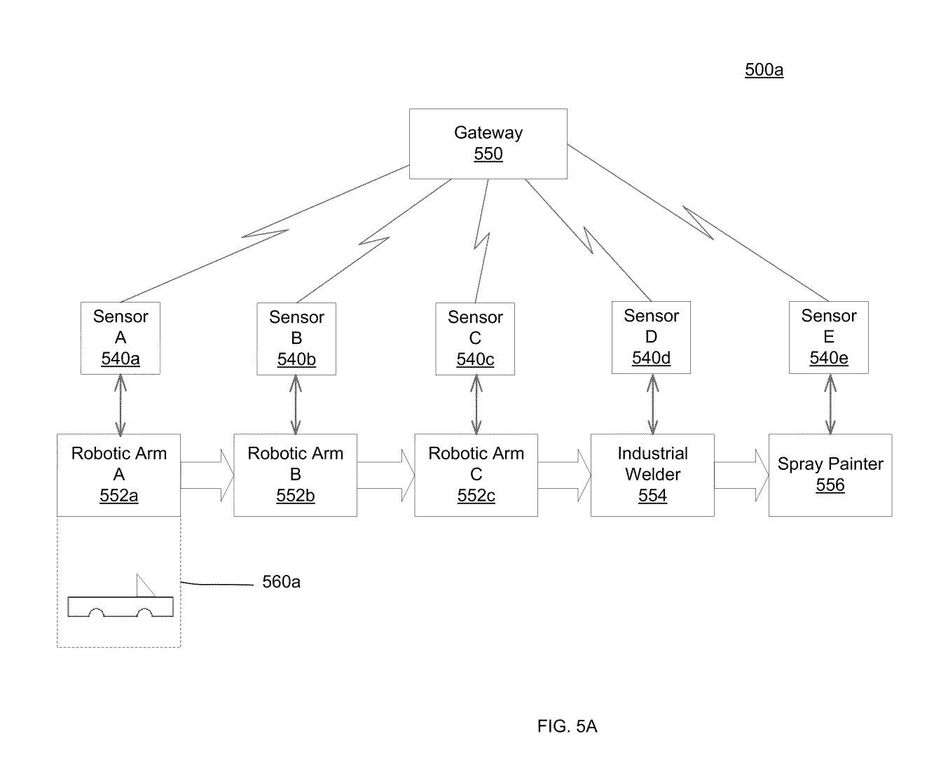

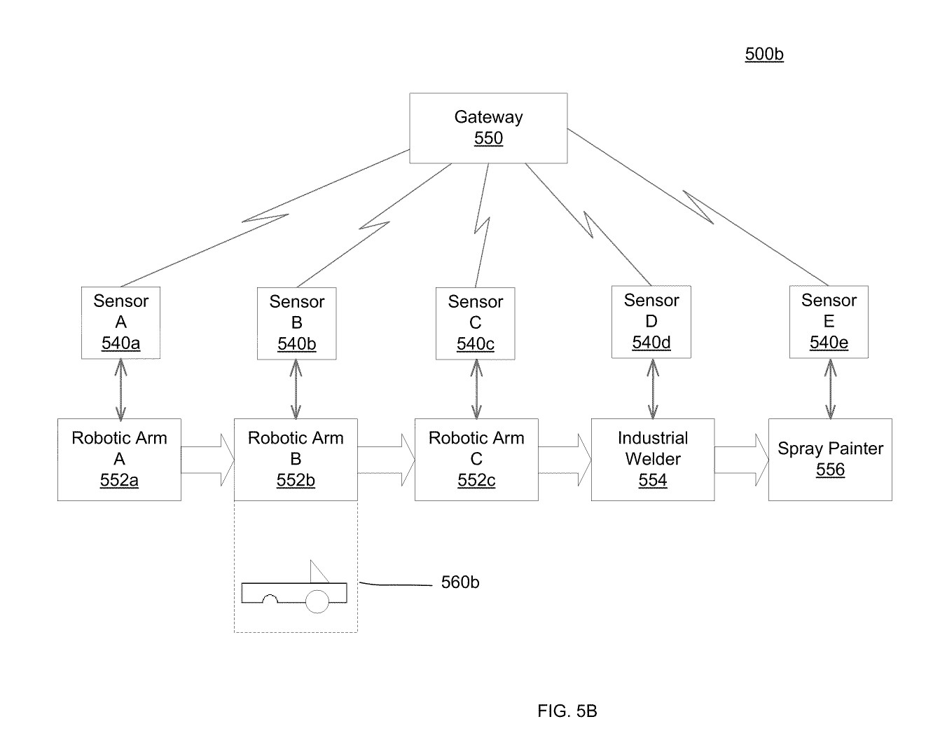

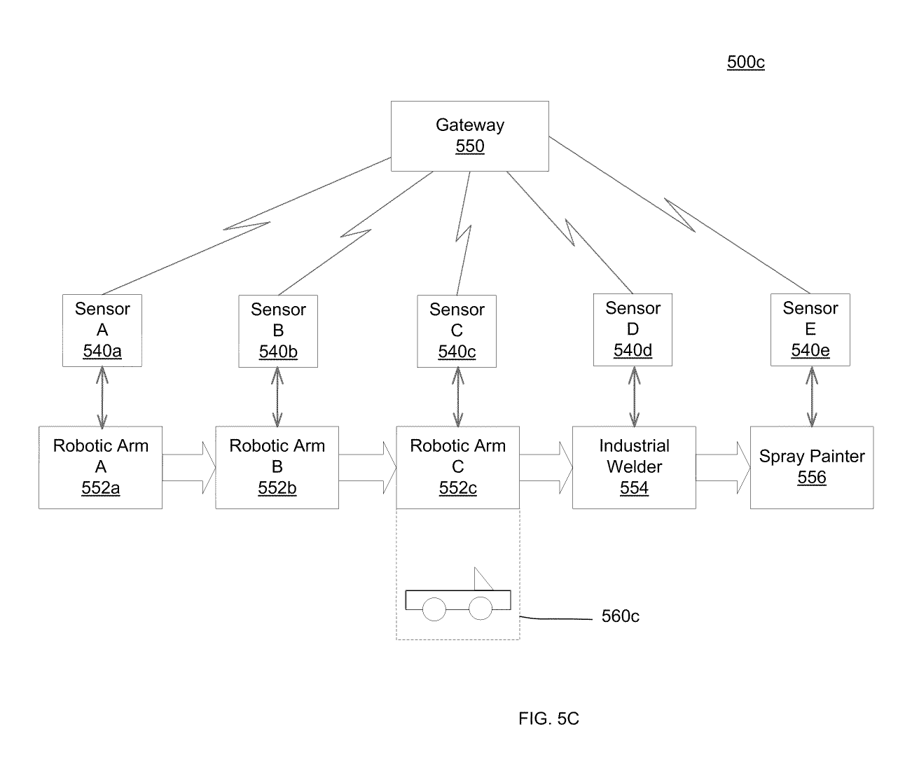

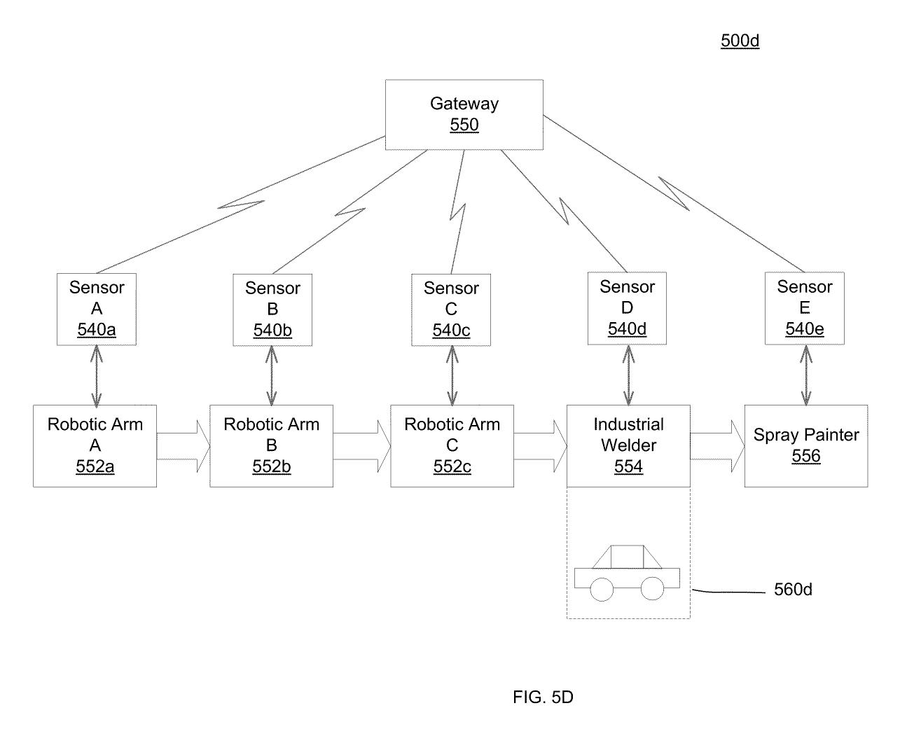

FIGS. 5A-5E illustrate wireless sensors A 540a, B 540c, C 540c, D 540d, and E 540e utilized in another exemplary low latency sensor network 500a-500e. Each wireless sensor A 540a, B 540c, C 540c, D 540d, and E 540e is associated with a machine, a robotic arm A 552a, a robotic arm B 552b, a robotic arm C 552c, an industrial welder 554, and a spray painter 556, respectively. The wireless sensors A 540a, B 540c, C 540c, D 540d, and E 540e communicate with a gateway 550 to transmit information associated with the events and/or to receive part or all of a schedule.

FIG. 5A illustrates a first event 560a in a sequence of events (in this example, assembly of a vehicle). The robotic arm A 552a performs the first event 560a (in this example, assembly of the parts of the vehicle). During an initialization period for the network 500a, the wireless sensor A 540a receives information associated with the event 560a from the robotic arm A 552a and/or sensors associated with the robotic arm A 552a. The wireless sensor A 540a communicates the information to the gateway 550. The wireless sensor A 540a receives part or all of a schedule from the gateway 550 after the gateway 550 determines the schedule for the network 500a. During an operating period for the network 500a, the wireless sensor A 540a transmits information regarding the first event 560a based on a schedule entry for the wireless sensor A 540a in the schedule.

FIG. 5B illustrates a second event 560b in a sequence of events (in this example, assembly of the vehicle). The robotic arm B 552b performs the second event 560b (in this example, assembly of the parts of the vehicle). During the initialization period for the network 500b, the wireless sensor B 540b receives information associated with the event 560b from the robotic arm B 552b and/or sensors associated with the robotic arm B 552b. The wireless sensor B 540b communicates the information to the gateway 550. The wireless sensor B 540b receives part or all of the schedule from the gateway 550 after the gateway 550 determines the schedule for the network 500b. During the operating period for the network 500b, the wireless sensor B 540b transmits information regarding the second event 560b based on a schedule entry for the wireless sensor B 540b in the schedule.

FIG. 5C illustrates a third event 560c in a sequence of events (in this example, assembly of the vehicle). The robotic arm C 552c performs the third event 560c (in this example, assembly of the parts of the vehicle). During the initialization period for the network 500c, the wireless sensor C 540c receives information associated with the event 560c from the robotic arm C 552c and/or sensors associated with the robotic arm C 552c. The wireless sensor C 540c communicates the information to the gateway 550. The wireless sensor C 540c receives part or all of the schedule from the gateway 550 after the gateway 550 determines the schedule for the network 500b. During the operating period for the network 500c, the wireless sensor C 540c transmits information regarding the third event 560c based on a schedule entry for the wireless sensor C 540c in the schedule.

FIG. 5D illustrates a fourth event 560d in a sequence of events (in this example, assembly of the vehicle). The industrial welder 554 performs the fourth event 560d (in this example, welding of the parts of the vehicle). During the initialization period for the network 500d, the wireless sensor D 540d receives information associated with the event 560d from the industrial welder 554 and/or sensors associated with the industrial welder 554. The wireless sensor D 540d communicates the information to the gateway 550. The wireless sensor D 540d receives part or all of the schedule from the gateway 550 after the gateway 550 determines the schedule for the network 500d. During the operating period for the network 500d, the wireless sensor D 540d transmits information regarding the fourth event 560d based on a schedule entry for the wireless sensor D 540d in the schedule.

FIG. 5E illustrates a fifth event 560e in a sequence of events (in this example, assembly of the vehicle). The spray painter 556 performs the fifth event 560e (in this example, spray painting the vehicle). During the initialization period for the network 500e, the wireless sensor E 540e receives information associated with the event 560e from the spray painter 556 and/or sensors associated with the spray painter 556. The wireless sensor E 540e communicates the information to the gateway 550. The wireless sensor E 540e receives part or all of the schedule from the gateway 550 after the gateway 550 determines the schedule for the network 500e. During the operating period for the network 500e, the wireless sensor E 540e transmits information regarding the fifth event 560e based on a schedule entry for the wireless sensor E 540e in the schedule.

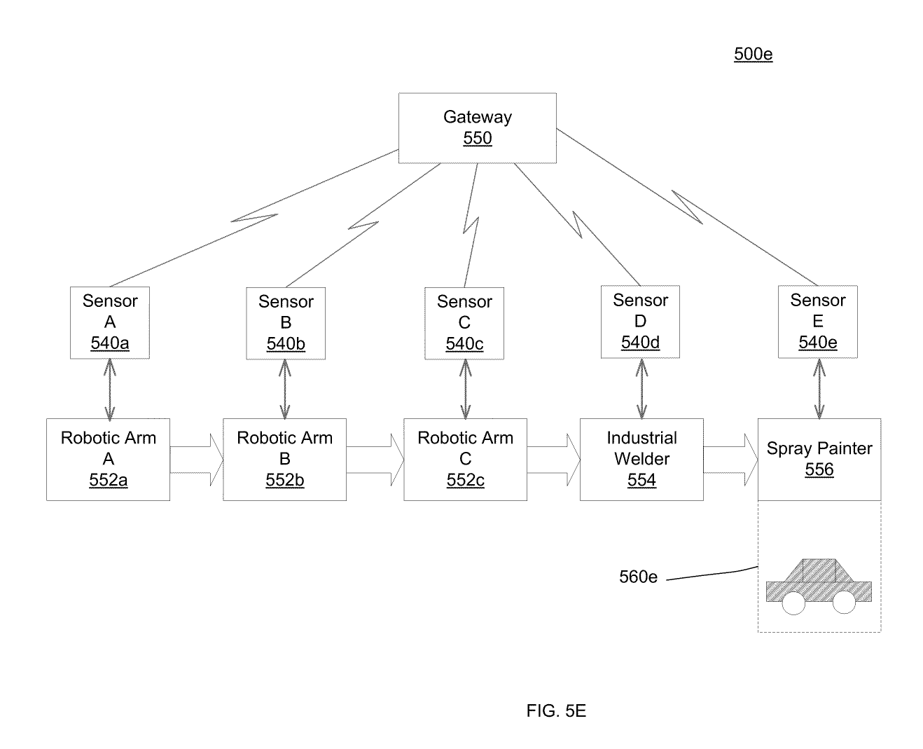

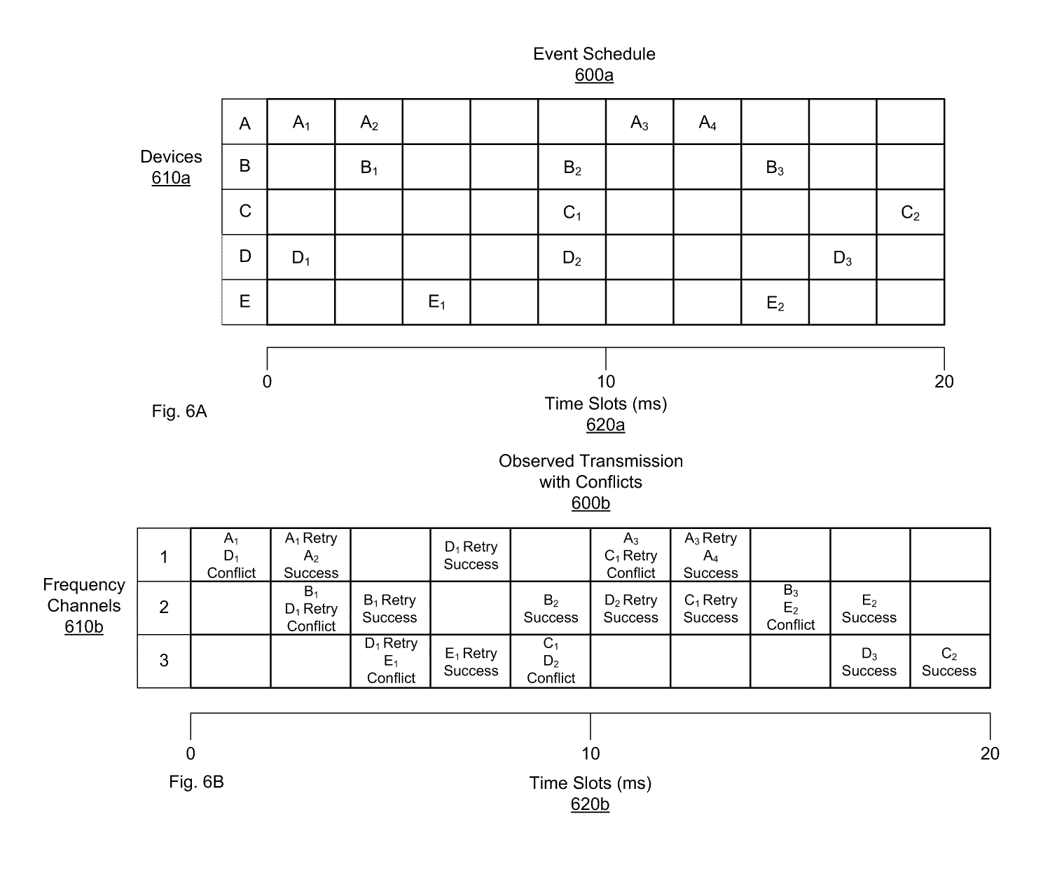

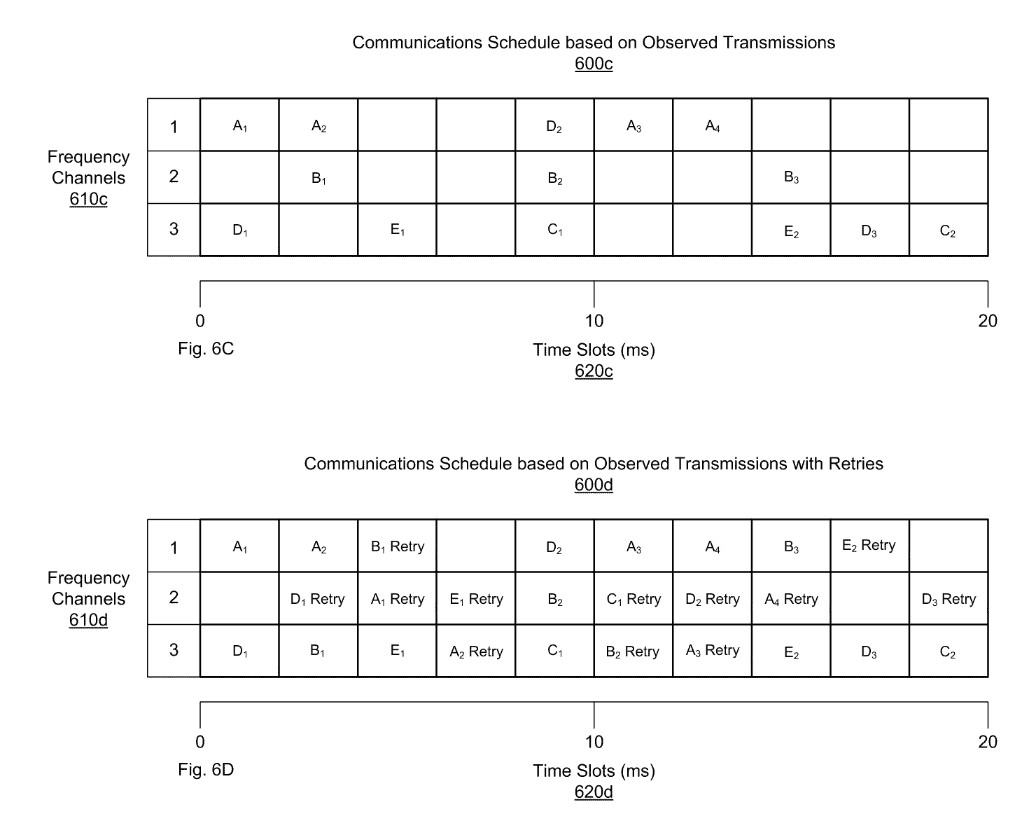

FIG. 6A depicts an exemplary event schedule 600a. The event schedule 600a includes devices 610a and time slots 620a. The event schedule 600a illustrates events in the sequence of events associated with network devices A, B, C, D, and E. The events in the event schedule 600a occur regardless of observed transmissions and/or any communication schedule.

FIG. 6B depicts exemplary observed transmissions 600b observed, for example, by the gateway 320 (FIG. 3). The observed transmissions 600b include observed frequency channels 610b and observed time slots 620b. Network devices A, B, C, D, and E transmit the transmissions based on the event schedule 600a (FIG. 6A). As illustrated in the observed transmissions 600b, the observed transmissions include six conflicts (in this example, A1/D1 on frequency channel 1 in time slot 0-2 ms, A3/C1 Retry on frequency channel 1 in time slot 10-12 ms, B1/D1 Retry on frequency channel 2 in time slot 2-4 ms, B3/E2 on frequency channel 2 in time slot 14-16 ms, D1 Retry/E1 on frequency channel 3 in time slot 6-8 ms, and C1/D2 on frequency channel 3 in time slot 8-10 ms).

In some examples, during the conflicts, the gateway 320 does not receive any information due to the conflict. As illustrated in the observed transmissions 600b, the respective network devices can send retry transmissions (e.g., A1 Retry, C1 Retry, etc.) if the respective network device does not receive an acknowledge of receipt from the gateway 320. The respective network devices can send the retry transmissions using a back-off schedule (e.g., pre-defined back-off schedule, dynamically determined back-off schedule, etc.). In other examples, the respective network devices can send a transmission that includes both a retry transmission and a standard transmission (e.g., A1 Retry and A2, A3 Retry and A4, etc.).

FIG. 6C depicts an exemplary communication schedule 600c determined, for example, by the gateway 320 (FIG. 3) based on the observed transmissions 600b (FIG. 6B) and/or the event schedule 600a (FIG. 6A). The communication schedule 600c includes frequency channels 610c and time slots 620c. The communication module 321 receives the observed transmissions 600b (FIG. 6B). The schedule module 324 determines one or more schedule entries for each of the network devices (in this example, network device A, network device B, network device C, network device D, and network device E) based on information associated with and/or within the observed transmissions 600b (e.g., frequency channel, time slot, event time slot, retry count, etc.). The observed transmissions 600b can include information associated with the event schedule 600a (e.g., the actual time for the event, etc.). The schedule module 324 determines schedule entries that occur at or after the observed time slots and/or the actual time slots of the event. The schedule module 324 can, for example, determine a schedule entry that minimizes the latency between the time of the actual event as illustrated in the event schedule 600a and the schedule entry associated with the event.

The first observed transmission 600b of the network device D (i.e. transmission for the event D1) conflicts with the observed transmission 600b of the network device A (i.e., the transmission for the event A1) on frequency channel 1 in times slot 0-2 ms. After this conflict, the network device A and the network device D can both use a back-off schedule mechanism (e.g., predefined and/or random/dynamic both in time domain and frequency domain back-off schedule mechanism) to retry the transmissions. In this example, the network device A retries the transmission associated with event A1 on frequency channel 1 in time slot 2-4 ms based on its back-off schedule mechanism, and network device D retries the transmission associated with event D1 on frequency channel 2 in time slot 2-4 ms based on its back-off schedule mechanism. By the time the network device A generates a transmission for the A1 Retry in time slot 2-4 ms, another actual event occurs which is event A2. In this example, the network device A combines the information about events A1 and A2 into one transmission on frequency channel 1 in time slot 2-4 ms. Since there is no other transmission on frequency channel 1 in time slot 2-4 ms, this communication from network device A is successful.

As a further example, the network device D makes the second attempt (i.e., D1 Retry) of the transmission associated with event D1 on frequency channel 2 in time slot 2-4 ms based on its back-off schedule mechanism. However, in this example, there is another event from another device (in this example, event B1 of the network device B) on the same frequency channel in the same time slot. In this example, there is a conflict between the transmission for event B1 and the transmission for the retry of event D1. The network device B uses a random back-off schedule (i.e., its back-off schedule mechanism) and retries the transmission for event B1 on frequency channel 2 in time slot 4-6 ms based on the random back-off schedule. The retry of the transmission for event B1 is successful. However, in this example, the second retry of event D1 on frequency channel 3 in time slot 4-6 ms conflicts again due to a new transmission for event E1 from the network device E. Due to this conflict, a third retry for the event D1 is necessary. The transmission for event D1 is finally successful at the third retry on the frequency channel 1 in time slot 6-8 ms.

As a further example, as illustrated in the event schedule 600a, the actual time for the event D1 is in time slot 0-2 ms. However, in this example, the gateway 320 is notified of the event much later in time at time slot 6-8 ms on the third retry of the D1 event due to the series of conflicts on previous transmissions of D1. When the communication associated with the event D1 is finally successful in time slot 6-8 ms, the communication includes the information of the actual time for the event D1 (in this example, time slot 0-2 ms). Therefore, in this example, the gateway 320 understands the event D1 occurred in time slot 0-2 ms, and the gateway 320 can, for example, schedule a time slot and frequency channel for D1 that is as close to the actual time for the event as possible while still avoiding any conflict with other events such as A1.

Based on the conflict and the subsequent retry transmissions, the schedule module 324 determines a schedule entry on frequency channel 2 in time slot 2-4 ms for the transmission B1 and schedule entry on frequency channel 3 in time slot 0-2 ms for the transmission D1. The schedule entry for the transmission B1 occurs at the respective event time slot, and the schedule entry for transmission D1 occurs at the respective event time slot.

FIG. 6D depicts another exemplary communication schedule 600d with retry slots determined, for example, by the gateway 320 (FIG. 3) based on the observed transmissions 600b (FIG. 6B) and/or the event schedule 600a (FIG. 6A). The communication schedule 600d includes frequency channels 610d and time slots 620d. After the schedule module 324 determines the one or more schedule entries for each of the network devices as illustrated in the communications schedule 600c. The schedule module 324 determines one or more retry entries (in this example, B1 Retry, etc.) in the communications schedule 600c based on the available schedule entries. As illustrated in the communications schedule 600d, the retry entries enable the network devices A, B, C, D, and E, respectively, to retry transmissions if there is a conflict and/or error in the transmission.

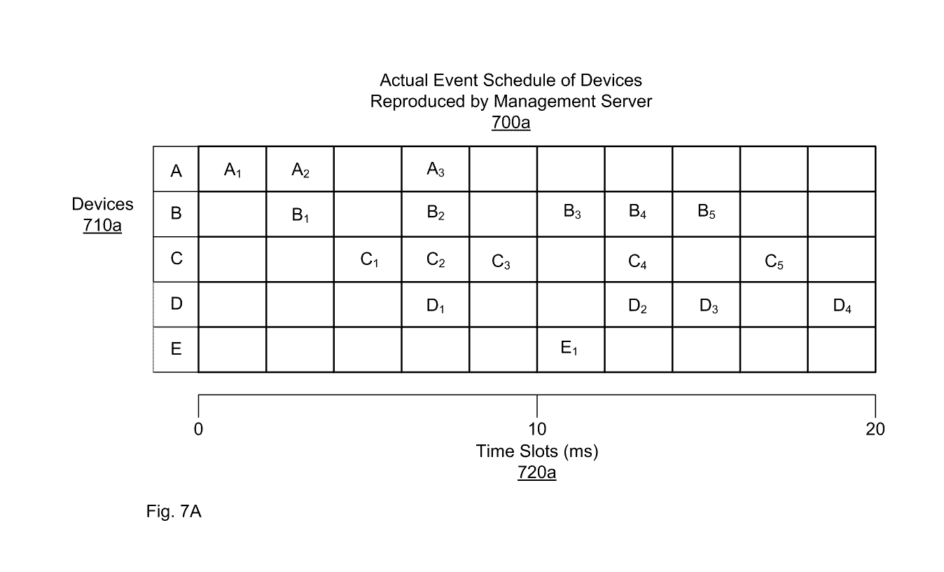

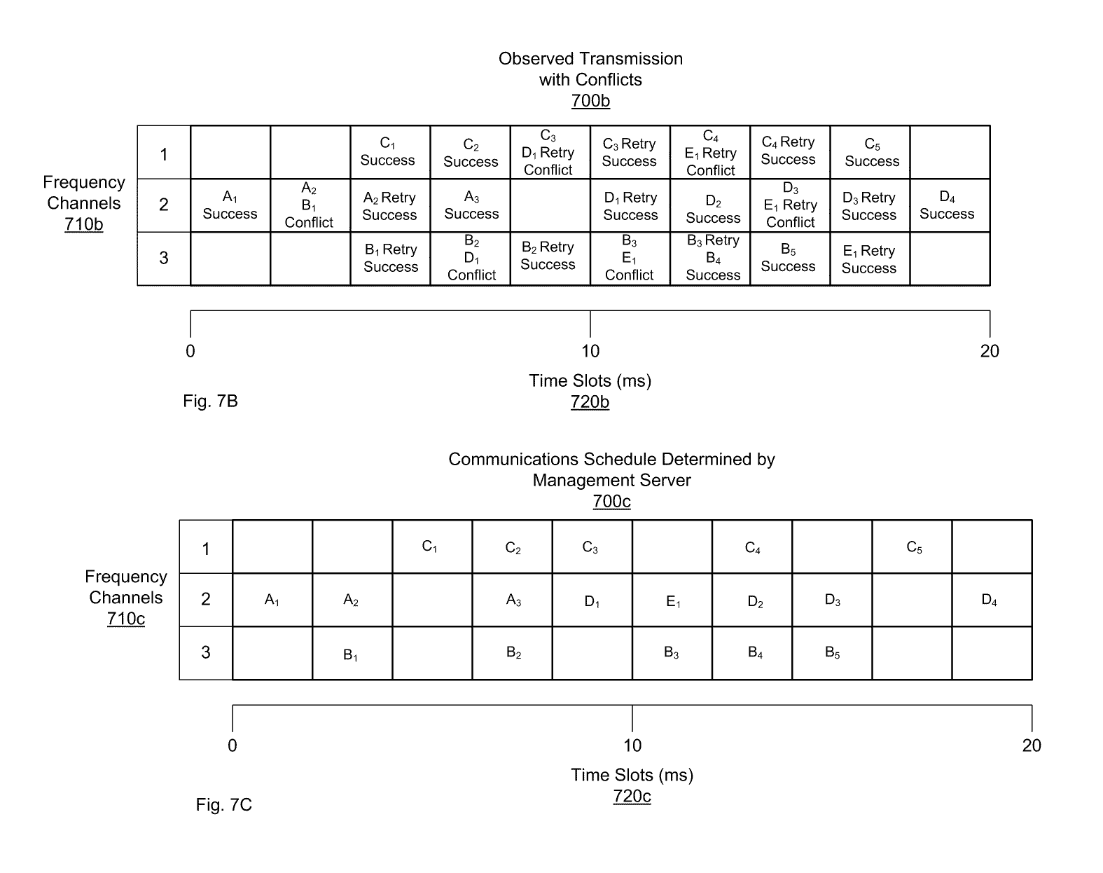

FIG. 7A depicts an exemplary event schedule 700a. The event schedule 700a includes devices 710a and time slots 720a. The event schedule 700a illustrates events in the sequence of events associated with network devices A, B, C, D, and E. The events in the event schedule 700a occur regardless of observed transmissions and/or any communication schedule.

FIG. 7B depicts an exemplary time-frequency map of observed transmissions 700b. The time-frequency map 700b includes frequency channels 710b and time slots 720b. Network devices A, B, C, D, and E transmit the transmissions as indicated in the time-frequency map 700b in a time order as indicated (in this example, C1, C2, C3 Retry, etc.). In this example, “C1” is the first event associated with network device C, “C2” is the second event associated with network device C, and “C3 Retry” is the third event associated with network device C of which communication is retried due to conflict of an earlier communication attempt (i.e., C3) with the transmission from another device in the same time slot and on the same frequency channel (in this example, D1 Retry).

In this example, as illustrated in the time-frequency map 700b, the transmissions include six conflicts (in this example, C3/D1 Retry on frequency channel 1 in time slots 8-10 ms, C4/E1 Retry on frequency channel 1 in time slot 12-14 ms, A2/B1 on frequency channel 2 in time slot 2-4 ms, D3/E1 Retry on frequency channel 2 in time slot 14-16 ms, B2/D1 on frequency channel 3 in time slot 6-8 ms, and B3/E1 on frequency channel 3 in time slot 10-12 ms). The six conflicts are illustrated in the time-frequency map 700b via the conflicting transmissions (e.g., A2/B1, C3/D1 Retry, C4/E1 Retry, etc.). However, in this example, the management server 210 does not receive any part of the transmissions since the transmissions conflict on the frequency channel.

Based on the observed transmissions 700b, the management server 210 can reproduce the actual timing of the events (i.e., actual event schedule 700a) as illustrated in FIG. 7A. Based on the actual event schedule 700a and/or the observed transmissions 700b, the management server 210 determines the communication schedule of each device to avoid any conflicts with other devices.

FIG. 7C depicts another exemplary communication schedule 700c determined, for example, by the management server 210 (FIG. 2) based on the time-frequency map 700b and/or actual event schedule 700a reproduced based on the time-frequency map 700b. The communication schedule 700c includes frequency channels 710c and time slots 720c. The communication module 211 (FIG. 2) receives the transmissions in the time-frequency map 700b of FIG. 7B. The schedule module 214 (FIG. 2) determines one or more schedule entries for each of the network devices (in this example, network device A, network device B, network device C, network device D, and network device E) based on the transmissions in the time-frequency map 700b and the actual event schedule 700a of the devices reproduced by management server 210. The schedule module 214 determines schedule entries that occur at or after the observed time slots and/or the actual time slots.

As illustrated, the transmissions in the time-frequency map 700b of the network device D conflict with the transmissions of the network device C on frequency channel 1 in time slot 8-10 ms (i.e., the transmission for event C3 conflicts with the retry transmission for event D1). Based on the actual event schedule 700a obtained via observing the transmissions 700b, the schedule module 214 determines schedule entries on frequency channel 1 in time slots 4-6 ms (event C1), 6-8 ms (event C2), 8-10 ms (event C3), 12-14 ms (event C4), and 16-18 ms (event C5) for the network device C and schedule entries on frequency channel 2 in time slots 8-10 ms (event D1), 12-14 ms (event D2), 14-16 ms (event D3), and 18-20 ms (event D4) for the network device D.

As a further example, the schedule entries for the network device C occur at the actual event time slots while taking into account the conflicts. The network device C first transmits the event C3 on the frequency channel 1 at time slot 8-10 ms, but retries the transmission on the frequency channel 1 at time slot 10-12 ms due to a conflict with D1 at the time slot 8-10 ms. In this example, the management server 210 schedules C3 on the frequency channel 1 at time slot 8-10 ms since the successful transmission for C3 at time slot 10-12 ms carries the information of the time that event C3 actually occurred, i.e., time slot 8-10 ms, and the subsequent transmissions C4 and C5 are scheduled following C3 on the frequency channel 1 at time slots 12-14 ms and 16-18 ms, respectively, based on the knowledge of actual schedule of events 700a.

As a further example, the schedule entries for the network device D occur at or after the actual event time slots while taking into account the conflicts. For example, the network device D first transmits D1 on the frequency channel 3 at time slot 6-8 ms, but the network device D retries the transmission of D1 on the frequency channel 1 at time slot 8-10 ms due to a conflict with B2. The retry of D1 event on the frequency channel 1 at time slot 8-10 ms fails again due to another conflict with C3. The network device D retries the event D1 again on frequency channel 2 at time slot 10-12 ms and this transmission is successful. In this example, after collecting the information about actual time of the event of D1 (i.e., 6-8 ms), the management server 210 determines the schedule entry of the frequency channel 2 at time slot 8-10 ms for D1 (in this example, not for time slot 6-8 ms which the event D1 actually occurred) since there is no free frequency channel available in time slot 6-8 ms after scheduling C2, A3, and B2 in the time slots. The management server 210 schedules the subsequent transmissions D2-D4 following D1 at time slots 12-14 ms, 14-16 ms, and 18-20 ms, respectively.

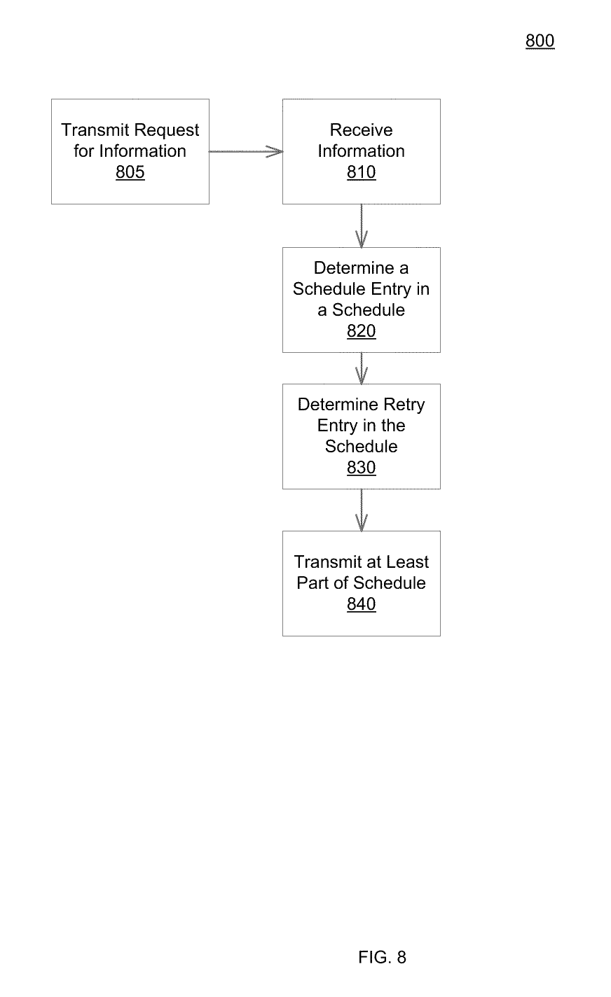

FIG. 8 depicts an exemplary flowchart 800 of a generation of a low latency sensor network communication schedule by, for example, the gateway 320 (FIG. 3) (also referred to as the initialization or startup phase). The communication module 321 (FIG. 3) transmits (805) a request for information to a plurality of network devices. The communication module 321 receives (810) information from the plurality of network devices (e.g., transmission timing, heartbeat packets, etc.). The scheduler module 324 (FIG. 3) determines (820) at least one schedule entry in a schedule for each of the network devices. The scheduler module 324 determines (830) one or more retry entries in the schedule for each of the network devices (in this example, if schedule entries are available in the schedule). The communication module 321 transmits (840) part or all of the schedule to each of the network devices.

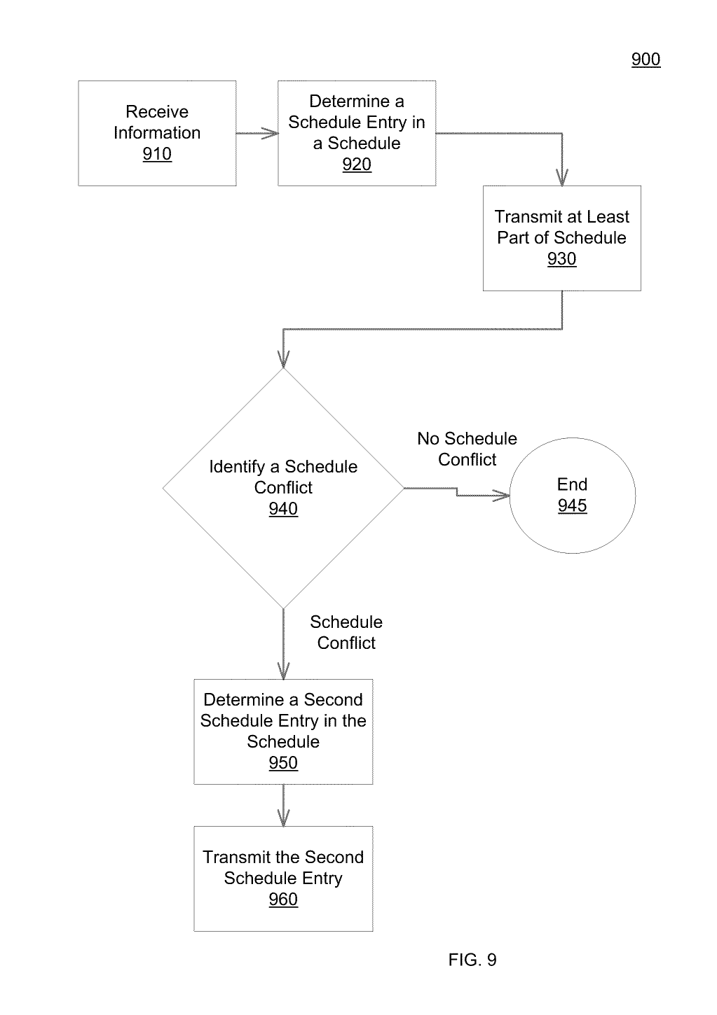

FIG. 9 depicts another exemplary flowchart 900 of a generation of a low latency sensor network communication schedule by, for example, the gateway 210 (FIG. 2) (also referred to as the initialization or startup phase). The communication module 211 (FIG. 2) receives (910) information from the plurality of network devices (e.g., transmission timing, heartbeat packets, etc.). The scheduler module 214 (FIG. 2) determines (920) at least one schedule entry in a schedule for each of the network devices. The communication module 211 transmits (930) part or all of the schedule to each of the network devices. The schedule conflict module 215 (FIG. 2) identifies (940) if there are any schedule conflicts within the network. If there are no schedule conflicts, the processing of the flowchart 900 ends (945). If there are schedule conflicts, the schedule conflict module 215 determines (950) a second schedule entry in the schedule for the conflicting schedule entries. For example, if schedule entries A2 and B1 conflict, the schedule conflict module 215 determines (950) a different schedule entry for A2 or B1 (e.g., based on the other schedule entries for the network devices, based on the timing and/or frequency of available schedule entries, etc.). The communication module 211 transmits (960) the second schedule entry to respective network device.

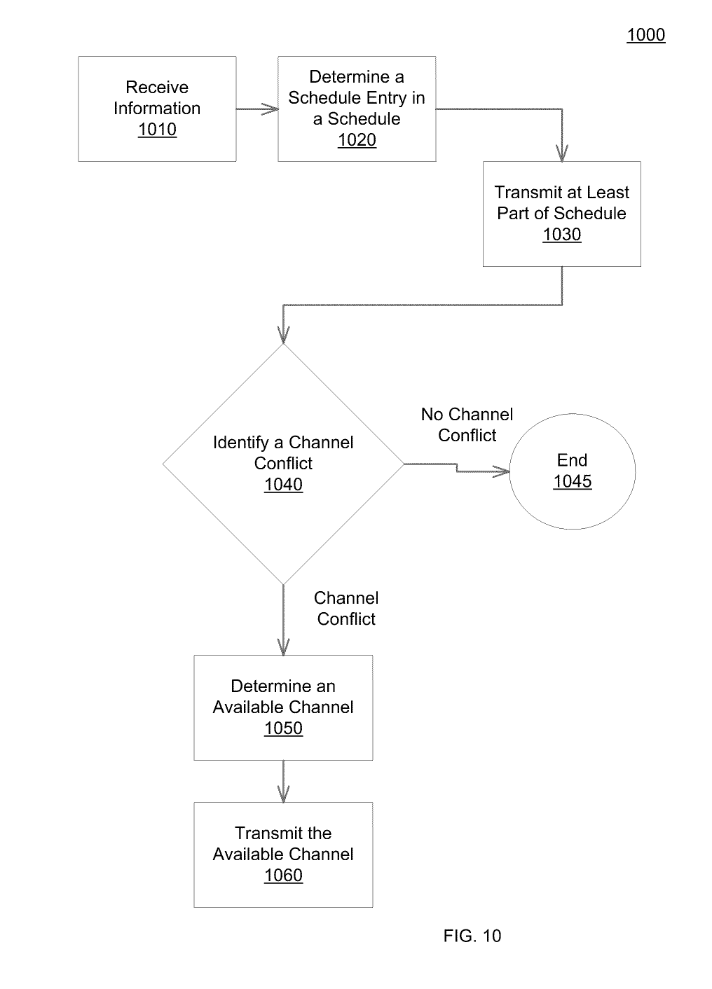

FIG. 10 depicts another exemplary flowchart 1000 of a generation of a low latency sensor network communication schedule by, for example, the gateway 210 (FIG. 2) (also referred to as the initialization or startup phase). The communication module 211 (FIG. 2) receives (1010) information from the plurality of network devices (e.g., transmission timing, heartbeat packets, etc.). The scheduler module 214 (FIG. 2) determines (1020) at least one schedule entry in a schedule for each of the network devices. The communication module 211 transmits (1030) part or all of the schedule to each of the network devices. The schedule conflict module 215 (FIG. 2) identifies (1040) if there are any channel conflicts within the network. If there are no channel conflicts, the processing of the flowchart 1000 ends (1045). If there are channel conflicts, the schedule conflict module 215 determines (1050) an available channel for the conflicting schedule entries. For example, if schedule entries A2 and B1 have a channel conflict, the schedule conflict module 215 determines (1050) a different channel for schedule entry A2 or B1 (e.g., based on the other schedule entries for the network devices, based on the timing and/or frequency of available schedule entries, etc.). The communication module 211 transmits (1060) the available channel to respective network device.

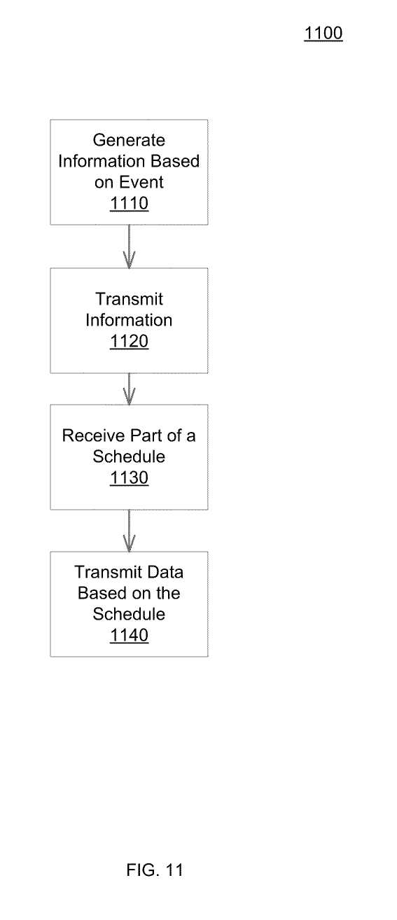

FIG. 11 depicts another exemplary flowchart 1100 of a generation of a low latency sensor network communication schedule by, for example, the wireless sensor 410 (FIG. 4). The control module 414 (FIG. 4) generates (1110) information based on an event in a sequence of events. The network interface module 418 (FIG. 4) transmits (1120) the information (e.g., to the gateway 320 (FIG. 3), to the management server 210 (FIG. 2), etc.). The network interface module 418 receives (1130) at least part of a schedule for the network 430. The network interface module 418 transmits (1140) data (e.g., sensor data, control data, etc.) based on the schedule.

In some examples, one or more schedule entries in the schedule are reserved for emergency and/or priority communication. For example, a schedule entry is reserved on each frequency every 10 ms for emergency communication. As another example, a frequency channel is reserved for priority communication (e.g., frequency channel 1 is reserved). The emergency and/or priority communication can be, for example, from emergency sensors (e.g., fire sensor, carbon dioxide sensor, etc.), priority sensors (e.g., shut-down sensor, engine heat sensor, etc.), and/or any other sensor with an emergency and/or priority message (e.g., output exceed pre-determined amount, humidity about a set threshold, etc.).

In some examples, the sequence of events is associated with a factory automation sequence (e.g., assembling a vehicle, assembling a machine, etc.). The sequence of events can be, for example, periodic or nearly periodic (e.g., random variance between cycles, standard variance between cycles, etc.). The sequence of events can include a plurality of subsequences of events.

In other examples, each schedule entry in the schedule includes a time slot, a frequency slot, or both. For example, each schedule entry is a time slot in a single frequency network—time slot=8-9 ms. As another example, each schedule entry is a time slot and a frequency slot for a network—frequency slot=2.422 GHz and time slot=4.5-7 ms.

In some examples, the network 100 (FIG. 1) utilizes an adaptive carrier sense multiple access (CSMA) (also referred to as “adaptive time division multiple access (TDMA)”) algorithm. The gateways 120 can, for example, communicate with each other in the available schedule entries of the schedule and/or in reserved gateway schedule entries.

In other examples, other wireless mesh nodes operate within the network 100. The other wireless mesh nodes can communicate in the free times in the network 100 (i.e., the available schedule entries in the schedule). If other wireless mesh nodes operate within the network 100, the scheduled network devices (in this example, sensor 140a, etc.) can be given priority over the other wireless mesh nodes or vice versa.

In some examples, a plurality of the gateways 120 (FIG. 1) operating in the same area (e.g., on the same factory floor, on parallel production lines, etc.) share their schedules with each other. The gateways 120 can adjust the schedules to remove any communication conflicts (e.g., frequency conflicts, communication with the same network device, etc.). In other words, different wireless networks 130 (FIG. 1) can utilize different frequency channels simultaneously, so that multiple wireless networks 130 can operate with their own network devices using different channels at the same time. This exemplary configuration of the technology advantageously increases the scalability of the system 100 by coordinating the schedules of the wireless networks 130 (i.e., less conflicts so less re-transmissions).

In other examples, the system 100 utilizes configuration and/or management features of other types of wireless sensor networks. The other types of wireless networks can include, for example, WirelessHART™ developed by the HART Communication Foundation, 6lowpan (internet protocol version 6 over low power wireless personal area networks, etc.) developed by the Internet Engineering Task Force, and/or any other wireless sensor network. It should be understood that the technology described herein can be implemented on any type of wireless network.

In some examples, the retry periods are scheduled within two retry schedule entries of the original schedule entry. For example, if the original schedule entry for B1 is at 2-4 ms, the retry schedule entries are at 4-6 ms and/or 6-8 ms. Since the technology described herein enables the event for each network device to be processed immediately with almost zero latency, the ability to retry within two retry schedule entries advantageously enables the satisfaction of maximum latency requirements (e.g., 5 ms) for various factory automation applications.

In other examples, the mechanical periodicity of a device is not accurate down to the time slot resolution in the schedule (e.g., 2 ms, 4 ms, etc.). For example, due to external factors such as temporary change of friction coefficient in the machine part, the period of each event can change. In this example, since each device part or all of the schedule, the device can use a different free schedule entry in the vicinity of the dedicated schedule entry. If this offset continuously shows up for a certain periodic event, the gateway 120 (FIG. 1) can identify the offset and shift the set schedule entry slot to a different available schedule entry based on the new timing.

In some examples, the maximum density of the network devices in the system is determined by the periods of the events of the network devices. For example, if there is a 0.5 second average stroke period for each network device, the system can accommodate up to two hundred and fifty devices in one wireless network with a 2 ms time slot for each device. To accommodate additional network devices, the system 100 can utilize multiple wireless networks 130 and/or multiple frequencies without sacrificing the scalability of each network.

In other examples, the schedule module 214 (FIG. 2) identifies at least one available schedule entry in the schedule for each network device. The at least one available schedule entry can occur at or after a time slot of the least one event associated with the respective network device (e.g., identification of further schedule entries, etc.).

In some examples, the schedule module 214 identifies at least one available schedule entry in the schedule for each network device based on schedule conflict information (e.g., conflict information from the network device, conflict information from the gateway, conflict information from the management server, etc.).

In other examples, the schedule module 214 determines at least one retry entry in the schedule for at least one network device of the at least two network devices based on the received information. For example, the schedule entry for the network device B is at frequency slot=1 and time slot=5-6 ms and the retry entry for the network device B is at frequency slot=2 and time slot=6-7 ms.

In some examples, the wireless sensor 140 (FIG. 1) receives information from the device (e.g., movement information from an embedded sensor within the device, control information from a control module within the device, etc.) and the wireless sensor 140 communicates the information to/from the wireless network 130 (FIG. 1). In this example, each pairing of the wireless sensor 140 (FIG. 1) and device can be referred to as the network device. In other examples, the device communicates information to/from the wireless network 130 and can be referred to as the network device (e.g., movement information sent directly from the device to the gateway 120, etc.). In some examples, the wireless sensor 140 determines information (e.g., humidity, temperature, etc.) and communicates the information to/from the wireless network 130. In this example, the wireless sensor 140 can be referred to as the network device. Any of the examples of the network device described herein can be utilized together or separately by the technology.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application specific integrated circuit). Subroutines and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be communication provided to the user in any form of sensory feedback (e.g., visual feedback, auditory feedback, or tactile feedback). Input from the user can, for example, be received in any form, including text, acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network).

The system can include clients and servers. A client and a server are generally remote from each other and typically interact through a communication network. The relationship of client and server arises by virtue of computer programs running on the respective computers and having a client-server relationship to each other.

Examples of communication networks include wired networks, wireless networks, packet-based networks, and/or circuit-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The network device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for scheduling transmissions in a network, the method comprising:
receiving information associated with at least two network devices, each network device associated with at least one event in a sequence of events;
determining a first schedule entry in a schedule for each of the at least two network devices based on the received information; and
transmitting at least a part of the schedule to each of the at least two network devices.

2. The method of claim 1, wherein the determining the first schedule entry further comprising identifying at least one available schedule entry in the schedule for each of the at least two network devices, the at least one available schedule entry occurring at or after a time slot of the least one event associated with the respective network device.

3. The method of claim 1, wherein the determining the first schedule entry further comprising identifying at least one available schedule entry in the schedule for each of the at least two network devices based on schedule conflict information.

4. The method of claim 1, further comprising:
identifying a schedule conflict associated with a network device based on schedule conflict information;
determining a second schedule entry in the schedule for the network device based on the identified schedule conflict; and
transmitting the second schedule entry to the network device.

5. The method of claim 4, further comprising generating the schedule conflict information based on the received information.

6. The method of claim 1, further comprising:
identifying a channel conflict associated with the schedule based on channel conflict information;
determining an available channel for the schedule; and
transmitting the available channel to each of the at least two network devices associated with the schedule.

7. The method of claim 6, further comprising generating the channel conflict information based on the received information.

8. The method of claim 1, further comprising determining at least one retry entry in the schedule for a network device based on the received information.

9. The method of claim 1, further comprising transmitting a request for the received information to the at least two network devices.

10. The method of claim 1, wherein the at least part of the schedule comprising the first schedule entry, a plurality of schedule entries before the first schedule entry in the schedule, a plurality of schedule entries after the first schedule entry in the schedule, or any combination thereof.

11. A method for scheduling transmissions in a network, the method comprising:
transmitting information associated with an event in a sequence of events;
receiving at least part of a schedule, the schedule generated based on the event in the sequence of events; and
transmitting data based on the at least part of the schedule.

12. The method of claim 11, further comprising generating the transmitted information based on the event.

13. A computer program product, tangibly embodied in an information carrier, the computer program product including instructions being operable to cause a data processing apparatus to:
receive information associated with at least two network devices, each network device associated with at least one event in a sequence of events;
determine a first schedule entry in a schedule for each of the at least two network devices based on the received information; and
transmit at least a part of the schedule to each of the at least two network devices.

14. A system for scheduling transmissions in a network, the system comprising:
a scheduler module configured to determine a first schedule entry in a schedule for each of at least two network devices based on information; and
a communication module configured to:
receive the information associated with the at least two network devices, each network device associated with at least one event in a sequence of events, and
transmit at least part of the schedule to each of the at least two network devices.

15. The system of claim 14, further comprising the schedule module further configured to identify at least one available schedule entry in the schedule for each network device, the at least one available schedule entry occurring at or after a time slot of the least one event associated with the respective network device.

16. The system of claim 14, further comprising the schedule module further configured to identify at least one available schedule entry in the schedule for each network device based on schedule conflict information.

17. The system of claim 14, further comprising:
a schedule conflict module configured to:
identify a schedule conflict associated with a network device of the at least two network devices based on schedule conflict information, and
determine a second schedule entry in the schedule for the network device based on the identified schedule conflict; and
the communication module further configured to transmit the second schedule entry to the network device.

18. The system of claim 14, further comprising:
a multi-network schedule conflict module configured to:
identify a channel conflict associated with the schedule based on channel conflict information, and
determine an available channel for the schedule; and
the communication module further configured to transmit the available channel to each of the at least two network devices associated with the schedule.

19. The system of claim 14, further comprising the schedule module further configured to determine at least one retry entry in the schedule for at least one network device of the at least two network devices based on the received information.

20. A system for scheduling transmissions in a network, the system comprising:
a network interface module configured to:
transmit information associated with an event in a sequence of events, and
receive at least part of a schedule, the schedule generated based on the event in the sequence of events; and
a control module configured to generate data for transmission based on the at least part of the schedule.

21. The system of claim 20, further comprising the control module further configured to generate the information based on the event.

22. A system for scheduling transmissions, the system comprising:
means for receiving information associated with at least two network devices, each network device associated with at least one event in a sequence of events;
means for determining a first schedule entry in a schedule for each of the at least two network devices based on the received information; and
means for transmitting at least a part of the schedule to each of the at least two network devices.
